(19) United States
(12) Patent Application Publication
(10) Pub. No.: US 2014/0289099 A1
(43) Pub. Date: Sep. 25, 2014

(54) LOAN STATUS MONITORING SYSTEM AND METHOD

(71) Applicant: MORTGAGE RESEARCH CENTER, LLC, Columbia, MO (US)

(72) Inventors: John Meyer, Columbia, MO (US); Matt Detelich, Columbia, MO (US)

(21) Appl. No.: 14/216,653

(22) Filed: Mar. 17, 2014

Related U.S. Application Data
(60) Provisional application No. 61/789,898, filed on Mar. 15, 2013.

(51) Int. Cl. G06Q 40/02

(52) U.S. Cl. CPC G06Q 40/025
USPC 705/38

(57) ABSTRACT

Methods are provided for monitoring an application process. These methods use multiple stages to receive an application on a submission date, set an estimated time for completion for each stage in the application process, and add the total estimated time for all of the plurality of stages to determine an initial estimated application process completion date. These methods can use feedback from multiple stages to continuously update an estimated closing date.

### CROSS-REFERENCE TO RELATED APPLICATIONS

This application claims the benefit of U.S. Provisional No. 61/789,898 filed Mar. 15, 2013, the entire contents of which are herein incorporated by reference.

### BACKGROUND

1. Field of the Invention

The present invention relates generally to the field of processing loan applications, more specifically to the systems and methods for monitoring loan status.

2. Description of the Related Art

Real property purchasers or holders may require financial assistance if they desire to purchase and do not currently possess sufficient assets. Individuals can consult loan institutions, such as various banks, finance agencies, credit unions, etc., to obtain the capital needed to make the large investment.

Typically, when an individual attempts to obtain a loan, they may be prequalified, or they may skip that step and simply apply for the loan. After the lending institution receives the application, a file is opened. The application is processed, and, if the initial consideration is favorable, the lender begins underwriting the loan. At any point during this process the lender may request more information and financial documents from the individual.

After the lender has decided to underwrite the loan, the pre-closing occurs, which can involve purchasing home owners insurance, providing remaining documentation, paying closing costs, or giving security to the lender. Then closing occurs, where title is transferred and closing costs are paid if the loan is a mortgage. Because of the uncertainty of the time required for processing and all other steps required in obtaining a loan, the closing date can often be uncertain. For example, if at any time the lender requires more information from the individual, the lender must contact the individual and the individual must provide the documentation. This can take more time than expected if the documents are not easily accessible, or simply due to scheduling conflicts.

It is known to use computer systems to assist with the processing of loan applications. For example, they (computer systems) can be used to analyze the data from the individuals seeking loans and provide loan assessments, as well loan packages, see, e.g., DeRoy et al. (U.S. Pat. No. 8,527,401). It is known to monitor the loan for the additional purpose such as evaluating jurisdictional taxes and fees, see, e.g., Ernst (U.S. Pat. App. Pub. No. 2011/0131119).

### SUMMARY

The present invention relates to a method for facilitating an application process consisting of multiple stages. In embodiments, the method includes setting an estimated time for completion for each stage in the application process, receiving an application on a submission date, and adding the total estimated time for completion for all the stages to determine an initial estimated application process completion date. At each stage, the method adds the time elapsed in earlier stages, adds the greater of the time in the current stage and the estimated time to complete the current stage, adds the estimated time required to complete all future stages, and expresses the sum of those processes as an earliest estimated closing date.

In terms of the stages, in one embodiment, there is an initial review phase involving review of the application to ensure that it meets formal requirements. Also, there is an added processing phase involving substantive review by an underwriter, the underwriter formulates a list of items that are needed for completion of the application. A third stage comprises an additional information phase. This is the phase in which the lender obtains additional financial information from the applicant. A fourth stage involves credit validation. More specifically, the credit validation stage involves requesting credit score information regarding the applicant. Finally, a fifth stage involves investigating and verifying at least one applicant representation. For each of these existing stages in the loan process, the processes in the last paragraph are employed to an earliest estimated closing date as the application process moves through the five stages.

The disclosed processes also involve displaying the earliest estimated closing date to users, e.g., lenders, applicants, and realtors. The communications can also involve transmitting e-mail notifications indicating significant deviations from the initial estimated closing date, displaying a warning to a borrower or a lender regarding delays in processing, or color-coding the warning displays by using one color to indicate the application is behind schedule, and another to indicate that the processing is on schedule.

The disclosed embodiment can also be expressed as a web-based tool for aiding the loan process. The tool uses a website to present an interface. Considering that the loan process has a number of stages, each stage involving different activities, the tool aids by providing a closing date estimator. The estimator continually updates and displays an estimated closing date upon completion of each stage in the application process.

Other features include a preapproval letter process where a user can print a pre-approval letter at any time after an actual preapproval by a bank, and before an applicant is under a contract to buy a home. An action item process is also included. The action item process helps users (i) view outstanding tasks related to each of the stages, and (ii) view expected receiving dates. Also, a comment log is made available to a plurality of parties interested in the application. The log enables them to enter information, or receive information relating to application status through the interface. Also included is a secure upload feature. The secure upload feature enables a user to securely upload documentation relating to the application to the website for use in the application process.

Also disclosed is a system. The system includes a website operating a web-based loan-facilitating computer process. The process has a closing date estimation feature which continually updates and displays an estimated closing date upon completion of each stage in the loan application process. The system also offers interfaces for the borrower, lender, or even in some embodiments, realtors.

### BRIEF DESCRIPTION OF THE DRAWINGS

FIG. 1 illustrates a system diagram for a computing environment in which one embodiment of the disclosed processes could be performed.

FIG. 2 illustrates a process flow diagram for one embodiment of the processes of the loan-status-monitoring tool of the present invention.

FIG. 3 illustrates typical loan timelines and how estimated closing dates are calculated.

### DETAILED DESCRIPTION

The disclosed systems and methods for monitoring loan status. In one aspect, the method continually calculates estimated closing dates based on various parameters. Unless otherwise specified, any terms used herein should be interpreted broadly and liberally to the extent allowed by the art and the meaning of the words offered in context. In one embodiment, the computer process (application) is a web-based interface that can be accessed by a borrower, their realtor, and/or a loan officer on the account. More specifically, loan officers and processors upload various documents and data with respect to the loan application. Once all required data has been submitted, the loan is ready to close.

The process is broken out into separate phases which are triggered when the loan process reaches chosen milestones. Each milestone has an expected number of days attributed to it as a lender's expectation. For example, a first stage of the process might be upon the initial receipt of the loan application. The lender's expectation might be that two days would be required to order: an appraisal, a title search, and an interest rate to complete this stage. A second stage might involve initial substantive review. As will be seen hereinafter, the embodiment disclosed herein includes five such stages. At each stage the process continually monitors progress, adjusts the closing date according to feedback received, and enables the display of a current updated closing date when needed.

As one skilled in the art will appreciate, the present invention may be embodied as, among other things: a method, system, or computer-program product. Accordingly, the present invention may take the form of a hardware embodiment, a software embodiment, or an embodiment combining software and hardware. In a preferred embodiment, the present invention takes the form of a computer-program product that includes computer-useable instructions embodied on a computer-readable medium.

Computer-readable media include both volatile and nonvolatile media, removable and nonremovable media, and contemplates media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. An exemplary modulated data signal includes a carrier wave or other transport mechanism. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

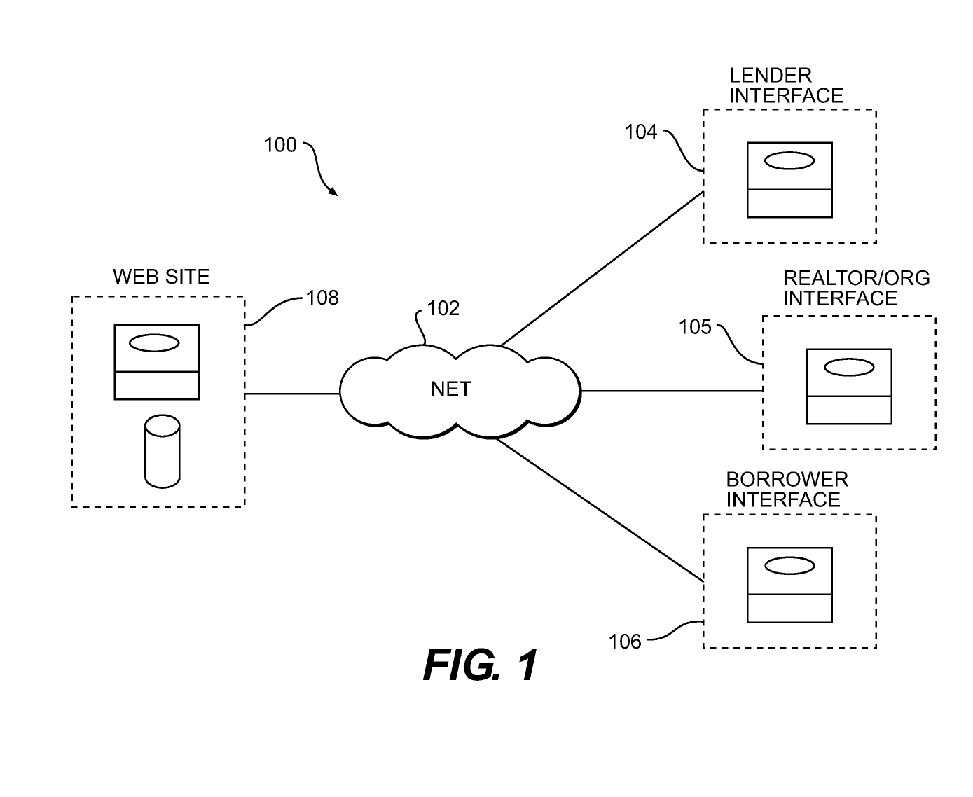

An embodiment of the present invention is shown in FIGS. 1-3. FIG. 1 discloses an embodiment for a system of the invention. Referring to the Figure, it can be seen that the system 100 is centered around a network, e.g., the internet 102. The invention uses a facilitating web application running at a site 108, which can be accessed by a lending institution 104 (or a plurality of lending institutions), realtor (and/or other third party or organization) 105, and a borrower 106. Facilitating website 108 operates using one or more web-enabled computing devices, e.g., servers, and executes a number of processes.

Preapproval Letter Process. One such process operable on site 108 is a pre-approval process. Using this process, borrowers (e.g., from computing device 106) and agents, e.g., from realtor interface 105, can print pre-approval letters from the application. This can occur at any time after actual preapproval by the bank, and before the borrower is under contract to buy a home.

Action Item Process. In another process, any of entities through interfaces 104, 105, or 106 can view outstanding items and expected receiving dates. For example, if an appraisal is not yet received, the viewer will see that when they log in through an interface. If the appraisal has already been ordered, that will be seen also, along with a date it is expected to be received. Whether or not an item has been ordered is manually updated at the website 108, and the expected delivery date is based on average turn-time for that particular task. The viewer enables the interested party to achieve online access to not only loan status information for any applications they are authorized to look at (e.g., realtors could look at numerous applications).

Comment Log Process. Another feature provided on website 108 is a comment log. The comment log is made available to all the parties interested in the transaction (through interfaces 104, 105, and 106; e.g., the borrower, a real estate agent, or loan officer) can enter information into, or receive information relating to loan status in one central location.

Secure Upload Process. Yet another feature provided here is a secure upload feature. A borrower might use the upload feature, if he or she sees that the bank needs more information from him/her. If so, that information can be uploaded directly through processes operating on server 108 in a secure way. This upload works on mobile devices as well as desktop and laptop browsers. Thus, a borrower could immediately snap a digital photo from a handheld device, and upload it into the system.

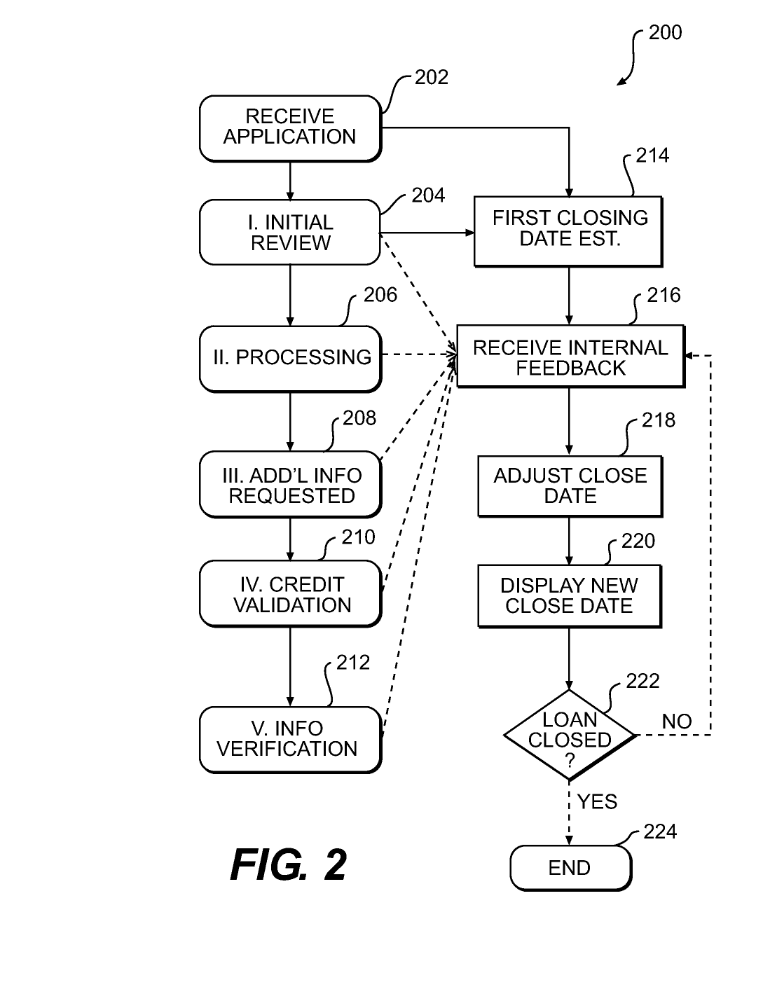

Loan-Tracker Process. FIG. 2 shows a loan-tracking process which is executed on web server 108. It should be recognized that the loan-tracking process of FIG. 2 can be operated in combination with the (i) preapproval letter, (ii) action item, (iii) comment log, and (iv) secure upload processes discussed above to provide the user with a highly-effective online session.

Referring to the loan-tracker process of FIG. 2, in a first step 202, a loan application is received from a potential borrower to kick off the loan application process. The process involves, in the current embodiment, five milestones, including an initial review step 204. As is known to those in the loan industry, initial review involves reviewing the application to see if it meets formal requirements, e.g., organizing submissions included with the application, doing a formal review of the paperwork, etc. Next, the application moves on to a processing step 206. This is where the first substantive review of the loan is made (typically in underwriting). Typically the handler (underwriter) will formulate a list of items that are needed for completion of the application, as well as listing verifications which need to be made. That initial substantive review almost always creates the need that additional information be received from the applicant. That additional information is requested in a step 208. The next milestone is a credit validation step 210 where typically the applicant's credit score is received and evaluated. After that, in a verification step 212, the potential lender will verify that certain information submitted by the applicant (e.g., employment at a job) by investigating via correspondence or other means. As will be discussed hereinafter, once each of these milestones are reached, information will be exchanged which involves the updating of projected closing dates.

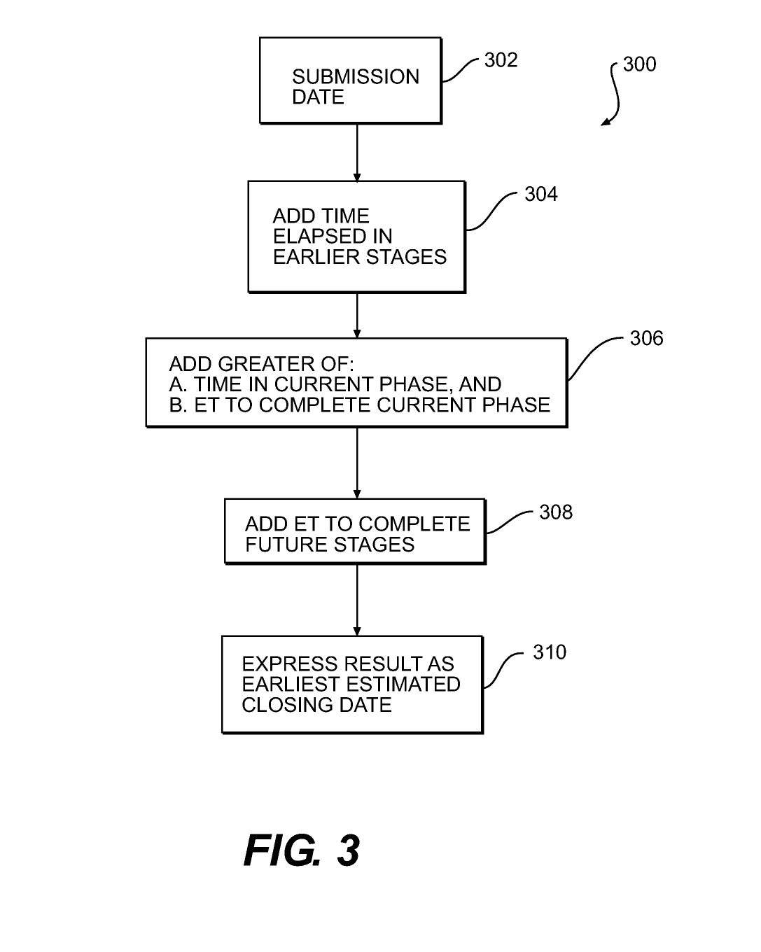

In a step 214, after the application is received in step 202, a first closing date is estimated. This is done by incorporating parameters into a formula. FIG. 3 shows this formula and how it is calculated both initially and as the process continues. Referring to the figure, it can be seen that

The first closing date is established using the amount of time it normally takes to complete activity on the loan at each milestone (e.g., milestones 202, 204, 206, 208, 210, and 212; FIG. 2). More specifically, each milestone has an expected number of days attributed to it as a company expectation.

For example, the beginning of the initial review process (step 204) is triggered by receipt of the loan application after the execution of receiving step 202. It may be an internal expectation that the initial review process of step 204 should take a standard number of days, e.g., two days. This might include steps such as ordering an appraisal, executing a title search, and establishing rates, all of which comprise a typical ATR form. Similar initial estimations of time required for each of steps 206, 208, 210, and 212 will also be made. These estimated times will all be added together to establish a first closing date estimate in a step 214.

Once the first closing date has been established in step 214, internal feedback will be continually received at each milestone (e.g., steps 206, 208, 210, and 212) in a step 216. (See FIG. 2) Thus, at the completion of processing step 206, the closing date will be updated in an updating step 218 according to the formula set out in FIG. 3.

As can be seen in the FIG. 3 flow, the updating step 218 begins with the application submission date in step 302. Using this established date as a starting point, the process 300 in FIG. 3 will be executed at each milestone reached (in the disclosed embodiment in FIG. 2, each of the five milestones 204, 206, 208, 210, and 212). Moving on to a step 304, all the time already and actually elapsed in the earlier stages is added.

Next, in a step 306, the process adds the greater of: (A) the time already elapsed in the current phase, and (B) the estimated time (ET) it will take to complete the future stages. The estimated time (ET's) for each stage is established by the mortgage company using historical information as a predictor, e.g., using averages, or other means. The ET's are factored into the formula as constants, but could, of course, be changed as needed over time, e.g., if typical processing times increase or decrease.

In step 308, the process adds the ET to complete all of the future stages. For example, if the overall process is at the initial interview stage of step 204, the already-established ET's for the processing stage (step 206), additional information requested stage (step 208), credit validation stage (step 210), and information verification stage (step 212) would all be added together along with the time already elapsed in steps 304 and 306.

Finally, the adjusted closing date resulting after executing steps 302-308 of the formula 300 represented by FIG. 3 is expressed as the earliest estimated closing date (step 310) and then displayed in a step 220.

One example of how the earliest estimated closing date is established using the formula of FIG. 3 is as follows:

Assume the estimated time to complete each of the five stages is predicted to be 2, 10, 5, 3, and 3 business days, respectively. If a loan begins on Mar. 3, 2014, then the loan would be expected to close 23 business days later, or on Apr. 2, 2014. If the closing date specified on the contract is on or after Apr. 2, 2014, the loan is said to be “On Track.” If, however, the contract closing date is prior to Apr. 2, 2014, the loan is said to be “Behind.” Table A below reflects how the process is set up from the start, with all Stages having estimated times for completion:

TABLE A
Start; Estimated Times

Began: Mar. 3, 2014
Stage 1 estimated completion (2 business days): 3/4
Stage 2 estimated completion (10 business days): 3/18
Stage 3 estimated completion (5 business days): 3/25
Stage 4 estimated completion (3 business days): 3/28
Stage 5 estimated completion (3 business days): 4/2
Closing date specified on the contract is 4/2.
Loan is On Track

Now assume the Stage 1 (e.g., Initial Review step 204 in FIG. 2) is completed in 1 business day, thus, one day faster than expected according to the 2 day estimate. Per the FIG. 3 processes, the timeline re-calculates to project an estimated closing date one day earlier than originally thought. Thus, we enter Stage 2 with 21 estimated business days remaining (10+5+3+3). This brings the estimated closing date to Apr. 1, 2014. The entire timeline gained 1 day, because Stage 1 was completed 1 day early. Thus, as a result, a display that the loan is on track (see step 220 in FIG. 2) and of the new closing date can be made by the website. See Table B below:

TABLE B
Initial Processing (Stage 1) Completed

Began: Mar. 3, 2014
Stage 1 actual completion (1 business day): 3/3
Stage 2 estimated completion (10 business days): 3/17
Stage 3 estimated completion (5 business days): 3/24
Stage 4 estimated completion (3 business days): 3/27
Stage 5 estimated completion (3 business days): 4/1
Closing date specified on the contract is 4/2.
Loan is On Track

This re-calculation of timelines continues as the loan progresses through each of the stages/phases (steps 204-212 in FIG. 2), always re-calculating an updated estimated closing date (according to the processes in FIG. 3). As a further example, assume that Stage 2 (processing/underwriting step 206 in FIG. 2) completes on Mar. 19, 2014, so took 12 business days to complete, which is 2 more days than expected. Table C reflects this:

TABLE C
Processing./UW (Stage 2) Completed

Began: Mar. 3, 2014
Stage 1 actual completion (1 business day): 3/3
Stage 2 actual completion (12 business days): 3/19
Stage 3 estimated completion (5 business days): 3/26
Stage 4 estimated completion (3 business days): 3/31
Stage 5 estimated completion (3 business days): 4/3
Closing date specified on the contract is 4/2.
Loan is Behind

Next, assume that the bank's requests for additional information discussed regarding step 208 in FIG. 2 (Stage 3) are completed on Mar. 26, 2014, thus, taking the expected time. The execution of the FIG. 3 ongoing calculations would look as appears in Table D:

TABLE D
Add's Info. Req. (Stage 3) Completed

Began: Mar. 3, 2014
Stage 1 actual completion (1 business day): 3/3
Stage 2 actual completion (12 business days): 3/19
Stage 3 actual completion (5 business days): 3/26
Stage 4 estimated completion (3 business days): 3/31
Stage 5 estimated completion (3 business days): 4/3
Closing date specified on the contract is 4/2.
Loan is Behind

Next, assume that the credit validations of step 210 in FIG. 2 are completed on Mar. 28, 2014. The continued calculations would be reflected as appears in Table E below:

TABLE E
Credit Validation (Stage 4) Completed

Began: Mar. 3, 2014
Stage 1 actual completion (1 business day): 3/3
Stage 2 actual completion (12 business days): 3/19
Stage 3 actual completion (5 business days): 3/26
Stage 4 actual completion (2 business days): 3/28
Stage 5 estimated completion (3 business days): 4/2
Closing date specified on the contract is 4/2.
Loan is On Track

Finally, in the next stage of the process (step 212 in FIG. 2) assume that the information verification takes the estimated time to complete (3 days). Thus, the loan will have closed on time as is reflected in Table F below:

TABLE F
Info. Verification (Stage 5) Completed

Began: Mar. 3, 2014
Stage 1 actual completion (1 business day): 3/3
Stage 2 actual completion (12 business days): 3/19
Stage 3 actual completion (5 business days): 3/26
Stage 4 actual completion (2 business days): 3/28
Stage 5 actual completion (3 business days): 4/2
Closing date specified on the contract is 4/2.
Loan is On Track

The display in a step 220 might occur in a variety of ways. First, the display might be made available upon a user calling up the application on a personal computer or wireless device located on the network 102. Further, in embodiments, e-mail notifications can be sent out indicating any deviations from the formerly established closing date. This may involve a warning that troublesome delays have occurred. In embodiments, the current status in terms of closing date can be displayed on a user interface accessed by a borrower on a computing device 106. Similarly, updated closing date information can be displayed to the lender on interface 104. It is possible that step 220 will involve the display of the new close date information in any variety of ways. Warnings could also be displayed to the borrower or lender regarding delays in the processing process (e.g., a red indicator for behind schedule loans versus a green indication for on-time processing). In terms of the receiving party of the display the earliest-estimated closing date, the communication might be made to one of a lender, the applicant, and a realtor.

Once the information has been displayed, an inquiry is made as to whether the loan is closed in a step 222. If the loan has not been closed, the process moves back to step 216 (see FIG. 2) where internal feedback is again received and moves through steps 218 through 222 continually. Thus, the closing date is maintained current and available for display upon on-line review by the borrower or lender. Once the loan is closed in step 222, the process is completed in a step 224.

The above described methods (processes), including portions thereof, can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the disclosed subject matter, the preceding description is intended to be exemplary only. It should not be used to limit the scope of the disclosure, which should be determined by reference to the following claims.

As can be seen, the present invention and its equivalents are well-adapted to provide a new and useful method for automating a process for monitoring loan processing timeliness. Many different arrangements of the various components depicted, as well as components not shown, are possible without departing from the spirit and scope of the present invention.

The present invention has been described in relation to particular embodiments, which are intended in all respects to be illustrative rather than restrictive. Alternative embodiments will become apparent to those skilled in the art that do not depart from its scope. Many alternative embodiments exist but are not included because of the nature of this invention. A skilled programmer may develop alternative means of implementing the aforementioned improvements without departing from the scope of the present invention.

It will also be understood that certain features and subcombinations are of utility and may be employed without reference to other features and subcombinations and are contemplated within the scope of the claims. Not all steps listed in the various figures need be carried out in the specific order described.

1. A method for facilitating an application process, the application process having a plurality of stages, each stage comprising different activities engaged in while moving forward in the application process, the method comprising:
setting an estimated time for completion for each stage in the application process;
receiving an application on a submission date;
adding the total estimated time for completion of all of the plurality of stages to determine an initial estimated application process completion date;
at each stage:
(a) adding the time elapsed in all earlier stages;
(b) adding the greater of (i) the time in the current stage, and (ii) the estimated time to complete that current stage;
(c) adding the estimated time required for completing all future stages; and
(d) expressing the sum of steps a-c as an earliest estimated closing date.

2. The method of claim 1 comprising:
including an initial review phase as one of the plurality of phases, the initial review phase involving review of the application to ensure that it meets formal requirements.

3. The method of claim 1 comprising:
including processing phase as one of the plurality of stages, the plurality phase involving substantive review by an underwriter, the underwriter formulating a list of items that are needed for completion of the application.

4. The method of claim 1 comprising:
including an additional-information phase as one of the plurality of stages, the additional-information phase involving obtaining additional financial information from the applicant.

5. The method of claim 1 comprising:
including a credit-validation phase as one of the plurality of stages, the credit-validation phase including requesting credit score information regarding the applicant.

6. The method of claim 1 comprising:
including an information-verification phase as one of the plurality of stages, the information-verification phase involving investigating and verifying at least one applicant representation made by the applicant in the application.

7. The method of claim 1 comprising:
enabling the display the earliest-estimated closing date to one of a lender, the applicant, and a realtor.

8. The method of claim 7 comprising:
transmitting e-mail notifications indicating any significant deviations from the initial estimated application process completion date.

9. The method of claim 7 comprising:
displaying a warning to one of a borrower or a lender regarding delays in the processing process.

10. The method of claim 9 comprising:
color-coding the warning by displaying one of a first color as an indication that the application is behind schedule, or a second color as an indication that the processing is on schedule.

11. The method of claim 1 comprising:
executing the method using a website.

12. The method of claim 11 comprising:
a preapproval letter process where a user can print a pre-approval letter at any time after an actual preapproval by a bank, and before an applicant is under a contract to buy a home.

13. The method of claim 11 comprising:
presenting through an interface an action item process wherein users can view outstanding items related to one or more of the plurality of stages, and view expected receiving dates.

14. The method of claim 11 comprising:
presenting through an interface a comment log made available to a plurality of parties interested in the application enabling said interested parties to enter information into, or receive information relating to application status in one central location.

15. The method of claim 11 comprising:
presenting through an interface a secure upload feature enabling a user to securely upload documentation relating to the application process to the website for use in the application process.

16. A web-based tool for aiding the loan process using a website to present an interface, the loan process having a plurality of stages, each stage comprising different activities engaged in, the tool comprising:
a closing date estimator, the estimator continually updating and displaying an estimated closing date upon completion of each stage in the application process;
a preapproval letter process where a user can print a pre-approval letter at any time after an actual preapproval by a bank, and before an applicant is under a contract to buy a home;
an action item process wherein users can view outstanding items related to one or more of the plurality of stages, and view expected receiving dates; and a comment log made available to a plurality of parties interested in the application enabling said interested parties to enter information into, or receive information relating to application status through the interface; and
a secure upload feature enabling a user to securely upload documentation relating to the application process to the website for use in the application process.

17. A system comprising:
a computing device available over a computer network, the computing device operating a web-based loan-facilitating process, the loan-facilitating process including a closing date estimation process, the closing date estimation process continually updating and displaying an estimated closing date upon completion of each of a plurality of stages existing in a loan application process;
a borrower interface enabling borrowers to obtain information regarding the loan application process; and
a lender interface enabling lenders to obtain information regarding the loan application process.

18. The system of claim 17 comprising:
a realtor interface enabling realtors to obtain information regarding the loan application process.
